(19) United States
(12) Patent Application Publication
(10) Pub. No.: US 2006/0061629 A1
(43) Pub. Date: Mar. 23, 2006

(54) Inkjet printer head and method of manufacturing the same

(76) Inventors: Sung-joon Park, Suwon-si (KR); Myong-jong Kwon, Suwon-si (KR); Kyong-il Kim, Seoul (KR); Kwang-ryul Kim, Suwon-si (KR); Nam-kyun Kim, Seongnam-si (KR); Yong-shik Park, Seongnam-si (KR); Eun-bong Han, Suwon-si (KR); Young-ung Ha, Suwon-si (KR); Jae-sik Min, Suwon-si (KR); Byung-ha Park, Suwon-si (KR)

Correspondence Address: STANZIONE & KIM, LLP, 919 18TH STREET, N.W., SUITE 440, WASHINGTON, DC, 20006, US

(21) Appl. No.: 11/071,350

(22) Filed: Mar. 4, 2005

(30) Foreign Application Priority Data
Sep. 17, 2004 (KR) 2004-74731

(51) Int. Cl. B41J 2/05

(52) U.S. Cl. 347/61

(57) ABSTRACT

An inkjet printer head includes a substrate having a manifold and an ink channel to supply ink, a nozzle plate formed on the substrate, a chamber formed between the substrate and the nozzle plate and extending toward the substrate and the nozzle plate, an electrode formed at an interface between the substrate and the nozzle plate and around the chamber, and a heater having both ends extending in contact with the electrode to be suspended on the chamber in direct contact with the ink and to generate bubbles from both surfaces thereof. The inkjet printer head is capable of improving manufacturing process efficiency by omitting a process of separately forming a heater passivation layer, operating the heater at low electric power by omitting the heater passivation layer, improving integrity of a nozzle by lowering a working voltage, and improving reliability in manufacturing processes by locating the suspended heater to be in parallel with the substrate and the electrode.

### CROSS-REFERENCE TO RELATED APPLICATIONS

This application claims the benefit of Korean Patent Application No. 2004-74731, filed Sep. 17, 2004, the disclosure of which is hereby incorporated herein by reference in its entirety.

### BACKGROUND OF THE INVENTION

1. Field of the Invention

The present general inventive concept relates to an inkjet printer head and a method of manufacturing the same, and more particularly, to an inkjet printer head to generate bubbles from upper and lower portions of a heater and a method of manufacturing the same.

2. Description of the Related Art

Generally, an inkjet printer head prints images with predetermined colors by ejecting ink droplets to a desired position of a recording medium. The inkjet printer head may generally be classified into two categories depending on an ejection mechanism used to eject the ink droplets. The inkjet printer head may be a thermal driving type that uses a heat source to generate bubbles in the ink and ejects the ink droplets by expansion force. The inkjet printer head may also be classified as a piezo-electric driving type that ejects the ink droplets using a piezo-electric material to generate pressure by deformation.

The ejection mechanism of the thermal driving type applies a pulse current to a heater made of a heat-generating resistance, thereby instantly heating ink adjacent to the heater up to about 300° C. The ink is boiled to generate bubbles, and the generated bubbles expand to apply pressure to the ink stored in an ink chamber. As a result, the ink in the ink chamber that is closest to a nozzle is ejected out of the ink chamber through the nozzle in a droplet shape.

In conventional thermal driving type printer heads, the heater is typically formed on a substrate, and the inkjet printer head is further classified into a top-shooting type, a side-shooting type, or a back-shooting type depending on a position and a driving type of the heater.

However, since all the bubbles are generated by a single surface of the heater (i.e., in only one direction), ink ejection performance of the heater has inherent limitations. In order to overcome these limitations, two heaters have been disposed on the substrate to improve the ink ejection performance. In this case, however, high integration of the nozzle is limited.

In addition, conventional heaters typically have heater passivation layers thereon. Therefore, in order to drive the heater, a large power is required, and the heater passivation layers restricts the high integration of the nozzle of the inkjet printer head.

### SUMMARY OF THE INVENTION

The present general inventive concept provides an inkjet printer head capable of improving ink ejection performance by generating bubbles from both sides of a heater by suspending the heater in a chamber.

The present general inventive concept also provides a method of manufacturing an inkjet printer head capable of operating at low electric power by omitting a passivation layer from the heater suspended in the chamber, and increasing motion reliability of the heater by forming the suspended heater in parallel with a substrate.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing an inkjet printer head including a substrate having a manifold on a rear surface thereof and an ink channel extending through the substrate to supply ink, a nozzle plate formed on the substrate, a chamber formed between the substrate and the nozzle plate and extending toward the substrate and the nozzle plate, an electrode formed at an interface between the substrate and the nozzle plate around the chamber, and a heater having both ends extending in contact with the electrode to be suspended in the chamber and to generate bubbles in the ink from both surfaces thereof.

The heater may include a surface at which a passivation layer is not formed so that the heater is in direct contact with the ink.

In addition, a photomask pattern to form the ink channel may be formed on the rear surface of the substrate by a laser machining process. The laser may be a KrF excimer laser. In addition, the ink channel may be formed by inductively coupled plasma etching.

The chamber may include a first chamber extending from the heater toward the substrate and a second chamber extending from the heater toward the nozzle plate.

Both ends of the heater may overlap with the electrode so that the heater is formed parallel with the electrode and the substrate.

An insulating layer may be formed between the heater and the electrode and may have a contact hole formed therein at which the heater overlaps with the electrode so that the heater is in contact with the electrode through the insulation layer.

The heater may be formed to a thickness of about 1000˜3000 Angstroms (Å).

The foregoing and/or other aspects and advantages of the present general inventive concept may also be achieved by providing a method of manufacturing an inkjet head, the method including forming an electrode in which a chamber region is patterned on a substrate and forming an insulating layer on the electrode except for on the chamber region; etching the chamber region into the substrate by a predetermined depth, filling the etched chamber region in the substrate with a first sacrificial layer, and planarizing the chamber region and the first sacrificial layer; forming a heater on the first sacrificial layer to be in contact with the electrode on both ends thereof; forming a second sacrificial layer on the heater and forming a nozzle plate having a nozzle on the second sacrificial layer; forming a manifold in a rear surface of the substrate, forming an ink channel pattern to define an ink channel on a photomask formed on the manifold using a laser, and etching the ink channel; and removing the first and second sacrificial layers to form a chamber that suspends the heater therein.

The heater may include a surface at which a passivation layer is not formed so that the surface is exposed to ink in the chamber.

The first and second sacrificial layers may comprise organic compounds.

The first and second sacrificial layers may subsequently be removed using any one of methyl, ethyl lactate, and glycol ether.

In addition, the chamber may include a first chamber formed by removing the first sacrificial layer and a second chamber formed by removing the second sacrificial layer. The first and second chambers are in fluid communication with each other.

The both ends of the heater may overlap with the electrode so that the heater extends in parallel with the electrode and the substrate.

The forming of the ink channel may include coating a photoresist on the manifold to form a photomask, irradiating the laser on the photomask to form the ink channel pattern, and etching the ink channel pattern.

In addition, the ink channel may be formed by inductively coupled plasma etching. The laser used to form the ink channel pattern may be a KrF excimer laser.

Furthermore, a contact hole is formed in the insulating layer at which the both ends of the heater are located so that both ends of the heater extend through the insulating layer and are in contact with the electrode.

In addition, the heater may be formed to a thickness of about 1000˜3000 Angstroms (Å), and formed of any material selected from a group including titanium nitride, tantalum, platinum, and tantalum nitride.

The chamber no including the thickness of the heater may have a height of about 5˜15 micrometers (μm).

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a partially cut out perspective view of an inkjet printer head according to the present general inventive concept;

FIG. 2 is a cross-sectional view illustrating an operation of the inkjet printer head of FIG. 1;

FIG. 3 is a cross-sectional view illustrating an operation of forming a barrier layer in a method of manufacturing the inkjet printer head of FIG. 1 according to the present general inventive concept;

FIG. 4 is a cross-sectional view illustrating an operation of forming an electrode in the method of manufacturing the inkjet printer head of FIG. 1;

FIG. 5 is a cross-sectional view illustrating an operation of forming a chamber region on the electrode in the method of manufacturing the inkjet printer head of FIG. 1;

FIG. 6 is a cross-sectional view illustrating an operation of forming an insulating layer and a contact hole in the method of manufacturing the inkjet printer head of FIG. 1;

FIG. 7 is a cross-sectional view illustrating an operation of forming a first chamber in the method of manufacturing the inkjet printer head of FIG. 1;

FIG. 8 is a cross-sectional view illustrating a state in which a surface planarization operation is commenced after filling a first sacrificial layer in the first chamber in the method of manufacturing the inkjet printer head of FIG. 1;

FIG. 9 is a cross-sectional view illustrating an operation of forming a heater in the method of manufacturing the inkjet printer head of FIG. 1;

FIG. 10 is a cross-sectional view illustrating an operation of forming a second sacrificial layer on a heater in the method of manufacturing the inkjet printer head of FIG. 1;

FIG. 11 is a cross-sectional view illustrating an operation of forming a nozzle plate in the method of manufacturing the inkjet printer head of FIG. 1;

FIG. 12 is a cross-sectional view illustrating an operation of forming a nozzle in the method of manufacturing the inkjet printer head of FIG. 1;

FIG. 13 is a cross-sectional view illustrating an operation of forming a manifold in the method of manufacturing the inkjet printer head of FIG. 1;

FIG. 14 is a cross-sectional view illustrating an operation of forming a photoresist layer on a rear surface of a substrate in the method of manufacturing the inkjet printer head of FIG. 1;

FIG. 15 is a cross-sectional view illustrating an operation of forming an ink channel pattern using an excimer laser in the method of manufacturing the inkjet printer head of FIG. 1;

FIG. 16A is a cross-sectional view illustrating a state in which an ink channel is formed in the method of manufacturing the inkjet printer head of FIG. 1;

FIG. 16B is a photograph depicting a state in which the ink channel is formed in the method of manufacturing the inkjet printer head of FIG. 1; and

FIG. 17 is a cross-sectional view illustrating an inkjet printer head after the method of manufacturing the inkjet printer head of FIG. 1 has been completed.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

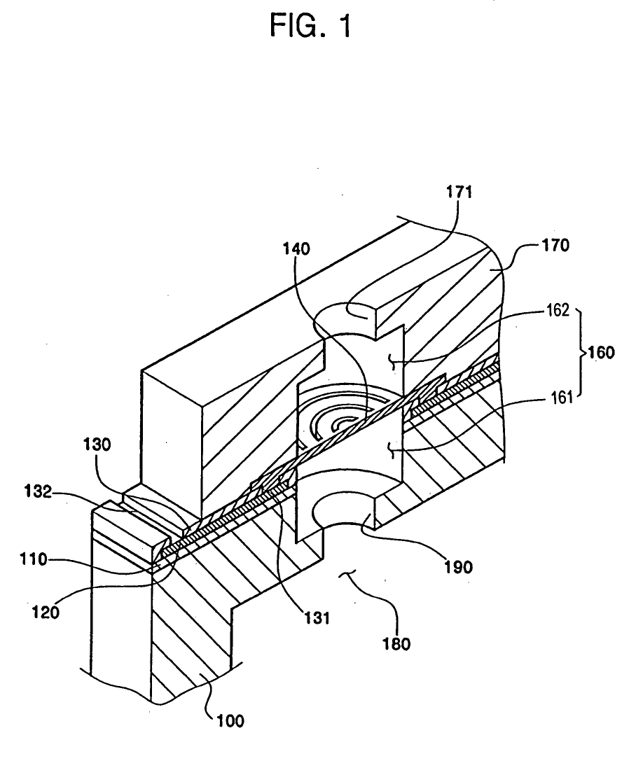

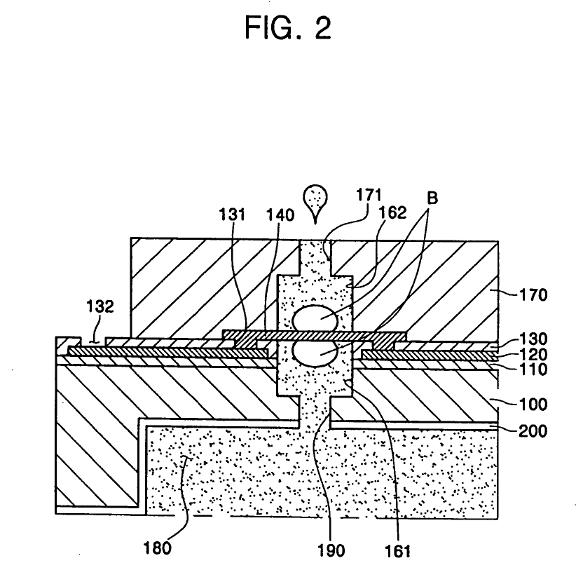

As illustrated in FIGS. 1 and 2, an inkjet printer head is provided with a manifold 180 formed at a rear surface of a substrate 100 in order to supply ink from an ink container (not shown) attached thereto. The substrate 100 may be a wafer used to manufacture a semiconductor integrated circuit. In addition, the manifold 180 is in fluid communication with the ink container (not shown), and an ink channel 190 is formed on the manifold 180 to extend through the substrate 100.

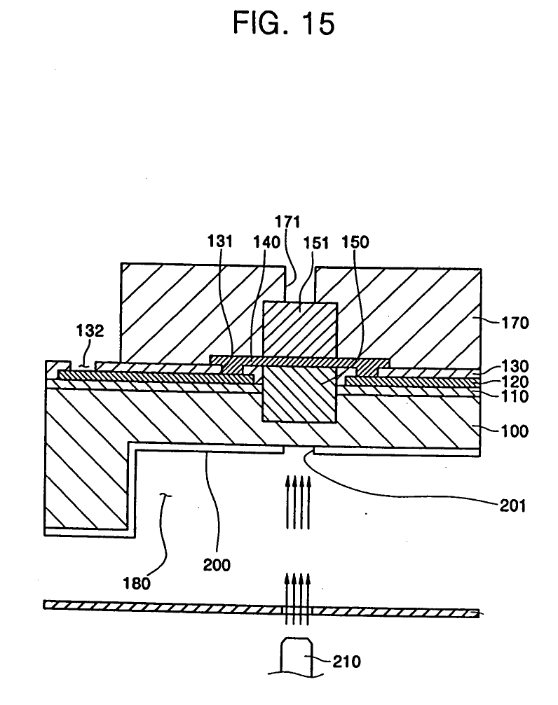

The ink channel 190 controls an ink ejection amount from the inkjet printer head and should be precisely formed in order to implement fine images. Since a diameter tolerance of the ink channel 190 should be adjusted to be less than 1 μm, an ink channel pattern 201 is formed using a photomask 200 and a laser 210 as illustrated in FIG. 15. The laser may be a KrF excimer laser. The ink channel pattern 201 (FIG. 15) is then used to form the ink channel 190. In addition, the ink channel 190 may be formed by inductively coupled plasma etching.

A nozzle plate 170 (i.e., a nozzle layer) having a nozzle 171 is disposed on the substrate 100, and a chamber 160 extending from the nozzle plate 170 toward the substrate 100 is disposed between the nozzle 171 and the ink channel 190. The chamber 160 may be divided into a first chamber 161 extending toward the substrate 100 and a second chamber 162 extending toward the nozzle plate 170. The first and second chambers 161 and 162 may be formed in a single circular pipe shape or polygonal shape. In other words, various shapes may be applied thereto.

A heater 140 is disposed between the first and second chambers 161 and 162. That is, the heater 140 is suspended in the chamber 160 and may also be formed in a circular or polygonal plate shape similar to the shape of the chamber 160.

In addition, the heater 140 is formed of a heat-generating resistance body made of any material selected from a group including titanium nitride, tantalum, platinum, and tantalum nitride.

Since the heater 140 is not provided with a separate heater passivation layer, the heater 140 may be formed to have a thickness of about 1000˜3000 Å, which is thicker than conventional heaters. In addition, since the heater 140 is not provided with the heater passivation layer, the heater 140 may be driven at low electric power. A leakage current may be generated when conductive ink is used, however, since the magnitude of the leakage current is small, no problems arise during a printing operation.

An electrode 120, comprised of aluminum or an aluminum alloy, is wired at an interface between the nozzle plate 170 and the substrate 100 around the chamber 160, and both ends of the heater 140 are in contact with the electrode 120.

An insulating layer 130 and a barrier layer 110, comprised of an oxide layer or a nitride layer, are formed on and under the electrode 120, respectively, to insulate the electrode 120 from the nozzle plate 170 and the substrate 100. A contact hole 131 is formed in the insulating layer 130 overlapping with the heater 140 to allow the electrode 120 to contact both ends of the heater 140. A bonding pad 132 may be formed at an outermost region of the insulating layer 130.

As illustrated in FIG. 2, in the inkjet printer head, the ink supplied from the manifold 180 through the ink channel 190 fills the first chamber 161 and then passes through the heater 140 to fill the second chamber 162 by a capillary phenomenon.

When a pulse current is applied to the heater 140 through the electrode 120, the heater 140 is heated to simultaneously boil the ink in the first and second chambers 161 and 162 on and under the heater 140, thereby generating bubbles B.

Subsequently, when the bubbles B continuously expand, the ink is ejected in a droplet shape from the second chamber 162 through the nozzle 171 by pressure generated by the expanded bubbles B. In addition, when the electrode 120 applied to the heater 140 is blocked, the heater 140 is cooled by the ink to shrink or explode the bubbles B. The chamber 160 is then refilled with ink from the manifold 180 to the first and second chambers 161 and 162 through the ink channel 190. Images may be printed on a recording medium by repeating these operations.

Hereinafter, a method of manufacturing an inkjet printer head in accordance with the present general inventive concept will be described with reference to FIGS. 1 and 3 to 16A. The accompanying drawings illustrate parts of the inkjet printer head formed on the substrate 100. However, it should be understood that several dozens to several hundreds of printer head chips may be manufactured on a single wafer in practice. In the drawings, the thickness of layers and regions are exaggerated or reduced for clarity.

The substrate 100 in accordance with an embodiment of the present general inventive concept may be a silicon substrate 100 having a thickness of about 600˜800 micrometers (μm). The substrate 100 may be used in manufacturing semiconductor devices and may be suitable to mass produce a plurality of inkjet printer heads according to the general inventive concept.

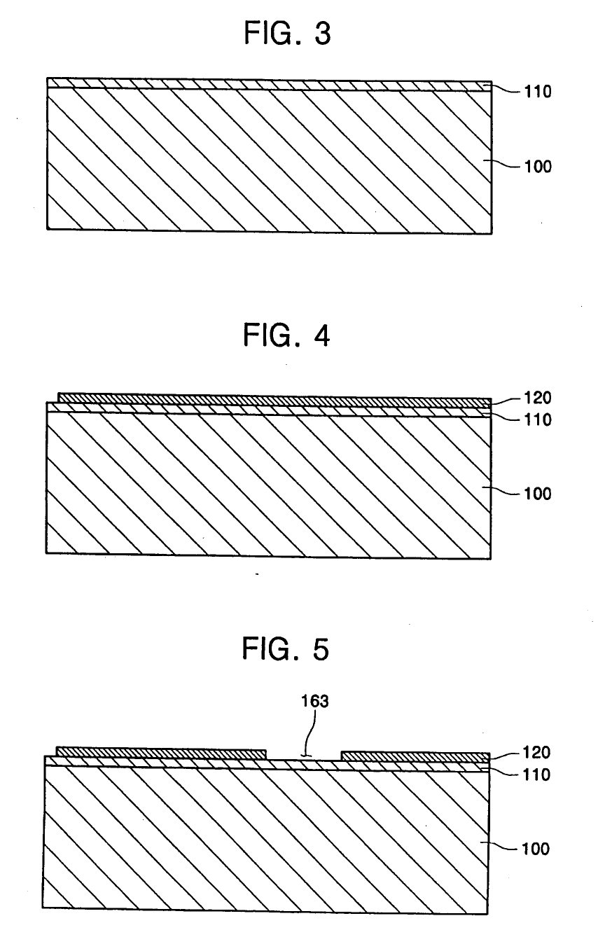

As illustrated in FIG. 3, a barrier layer 110 is formed on the substrate 100. The barrier layer 110 may be formed of an oxide layer or a nitride layer. If the barrier layer 110 is an oxide layer, the substrate 100 is inserted into a diffusion furnace to form the oxide layer to be oxidized so that a silicon oxide layer, which will become the barrier layer 110, is formed on a surface of the substrate 100.

On the other hand, if the barrier layer 110 is a nitride layer, a method of performing a rapid temperature process (RTP) of applying thermal energy to a nitrogen source gas and a method of applying plasma power to the nitrogen gas to activate the nitrogen gas together with the RTP may be used to form the nitride layer. Recently, the method of applying the plasma power has been widely used. The source gas may be a nitrogen gas or an ammonia gas.

As illustrated in FIG. 4, an electrode 120 is formed on the barrier layer 110. The electrode 120 may be formed by depositing aluminum or an aluminum alloy of a thickness of about 1 micrometer (μm) on the barrier layer 110 using a sputtering method.

A photoresist process is performed on the electrode 120 to form a photoresist pattern to define a chamber region 163 on the electrode 120. As illustrated in FIG. 5, the electrode 120 is then patterned to expose the chamber region 163. Once the electrode 120 is patterned to include the chamber region 163, the barrier layer 110 is exposed by the chamber region 163.

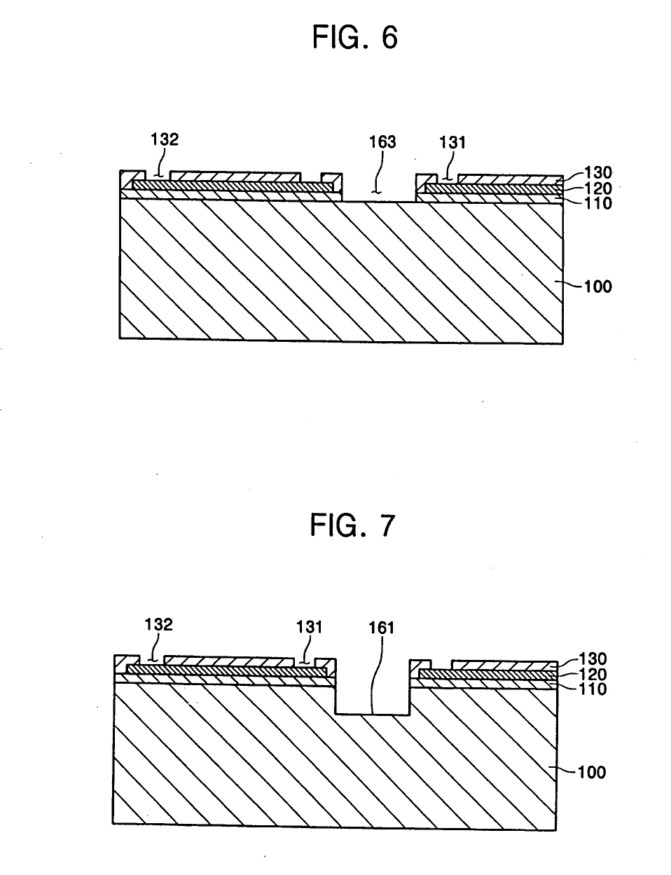

As illustrated in FIG. 6, an insulating layer 130 may be deposited on the electrode 120. The insulating layer 130 may be deposited by the same method as the process of forming the barrier layer 110. A photolithography process is performed to selectively etch the insulating layer 130 to expose the chamber region 163 and to form a contact hole 131 and a bonding pad 132 in the insulating layer 130. A photolithography process may then be performed to form a photoresist mask at which the chamber region 163 is patterned on the insulating layer 130.

As illustrated in FIG. 7, the exposed barrier layer 110 may be removed by wet etching using hydrofluoric acid (HF) or dry etching to expose the substrate 100 in the chamber region 163. The exposed substrate may then be etched using dry or wet etching to form a first chamber 161. The first chamber 161 formed by etching may have a depth of about 6˜10 micrometers (μm).

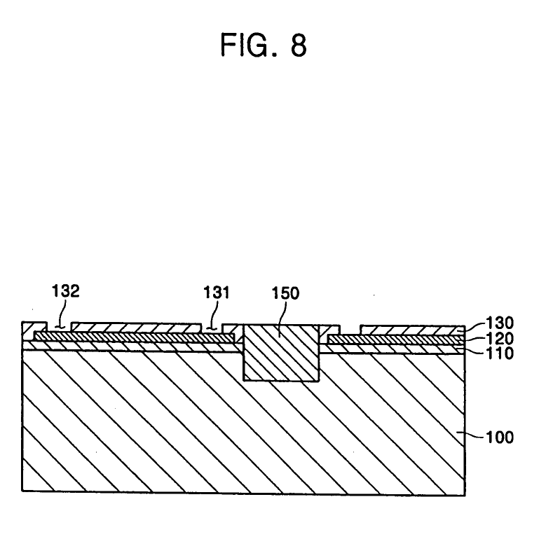

As illustrated in FIG. 8, the first chamber 161 may be filled with an organic compound to form a first sacrificial layer 150, and then a surface planarization process is performed. The organic compound filled as the first sacrificial layer 150 may be any material selected from a group including polyamide, polyimid, and resin.

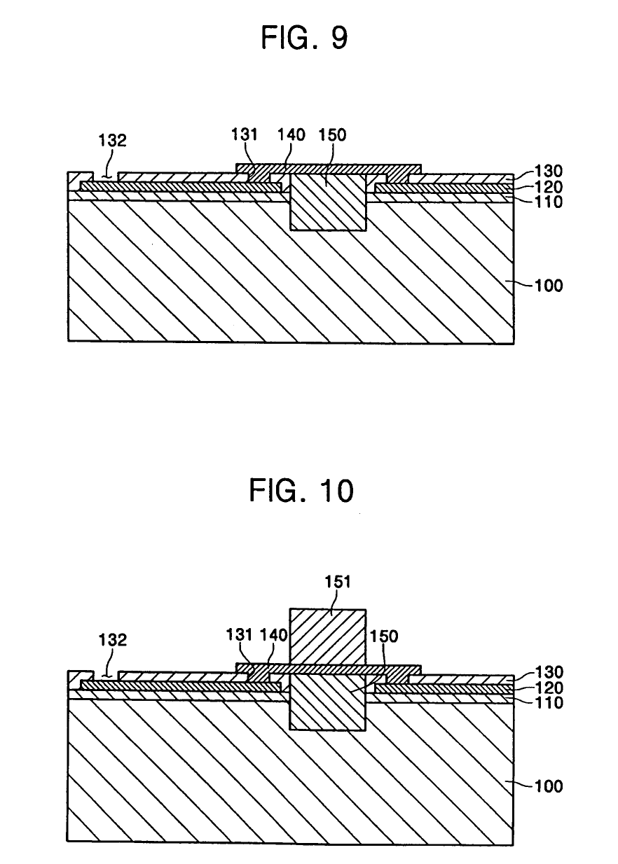

As illustrated in FIG. 9, a heater 140 is deposited and formed on the planarized surface. The heater 140 may be formed by patterning in an annular or other predetermined shape on the planarized surface. In this process, the heater 140 is made of a heat-generating resistance body formed of any material selected from a group including titanium nitride, tantalum, platinum, and tantalum nitride.

The heater 140 may be deposited by a sputtering method or a chemical vapor deposition (CVD) method to have a thickness of about 1000˜3000 Angstroms (Å). When the heater 140 has a thickness of 1000 Å or less, the heater 140 may have problems with durability, and when the heater 140 has a thickness larger than 3000 Å, a resistance value may become low, and the low resistance value makes it difficult to actually apply the heater 140. Therefore, the heater 140 may be formed within the aforementioned thickness such that the heater 140 has an appropriate resistance value according to its width and length.

The contact hole 131 may include one or more holes on each side of the first sacrificial layer 150. When forming the heater 140, both ends of the heater 140 are formed to fill the contact hole 131 to be in contact with the electrode 120 through the contact hole 131 of the insulating layer 130.

As illustrated in FIG. 10, a second sacrificial layer 151 may be formed on the heater 140 to form a second chamber 162. The second sacrificial layer 151 may be formed to have a thickness of about 6˜10 micrometers (μm). The method of forming the second chamber 162 may include molding an organic compound like the first sacrificial layer 150 to a thickness of about 6˜10 μm, exposing, developing, and removing a remaining portion of the organic compound except for the second sacrificial layer 151.

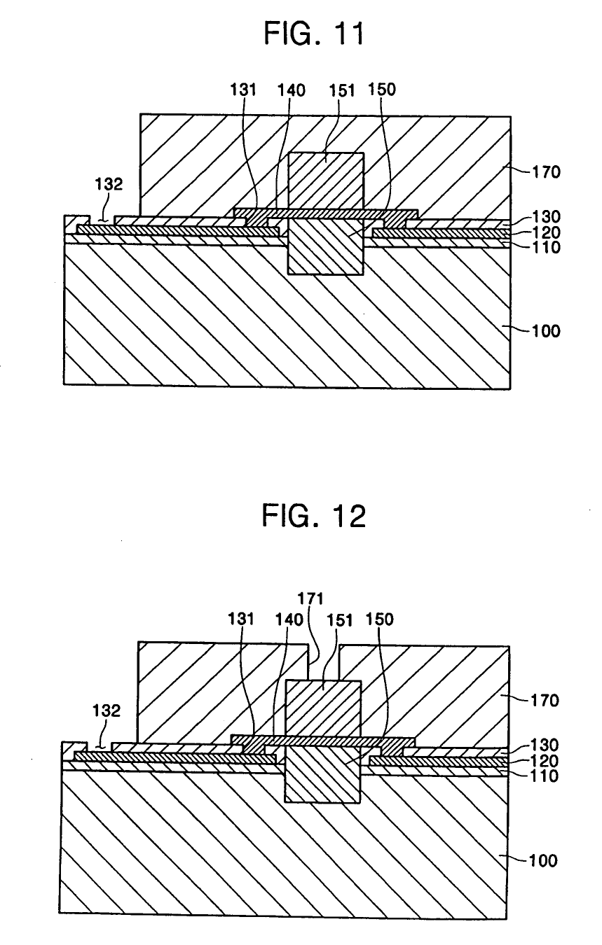

As illustrated in FIG. 11, a nozzle plate 170 may be formed above the substrate 100 by a molding method. The nozzle plate 170 may be made of epoxy-based, polyimid-based material, or other materials. Then, as illustrated in FIG. 12, an upper center portion of the nozzle plate 170 may be wet or dry etched to form a nozzle 171 above the second sacrificial layer 151.

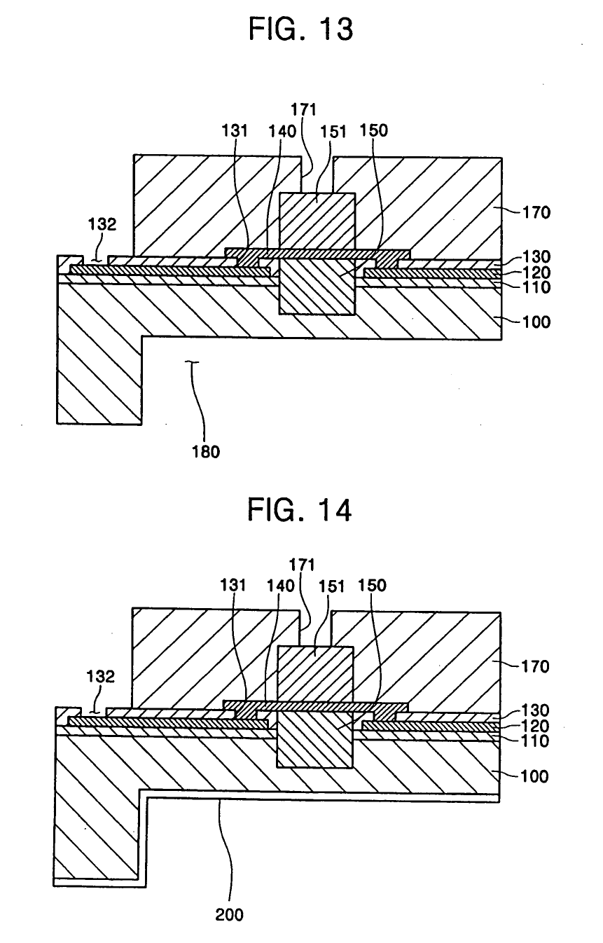

As illustrated in FIG. 13, a manifold 180 is then formed on a rear surface of the substrate 100 by dry or wet etching. The manifold 180 is formed by depositing a silicon oxide layer having a thickness of about 1 micrometer (μm) using an etching mask material on the rear surface of the silicon substrate 100. The silicon oxide layer may then be patterned and used an etching mask (not shown) to define a region of the manifold 180 that is to be etched in the substrate 100.

The silicon substrate 100 exposed by the etching mask may then be wet etched using a tetramethyl ammonium hydroxide (TMAH) etching solution for a predetermined time or dry etched by inductively coupled plasma etching.

Once the manifold 180 is formed, as illustrated in FIG. 14, a photoresist may be applied on a surface of the manifold 180 using spray coating. A photomask 200 may be formed and patterned to define an ink channel pattern 201 where an ink channel 190 is to be formed.

As illustrated in FIG. 15, patterning the photomask 200 is performed using a laser. The laser may be a KrF (krypton fluorine) excimer laser. The KrF excimer laser provides a short wavelength suitable to use in deep ultra violet (DUV). Alternatively, ArF, KrCl, XeCl, or XeF excimer laser may be used.

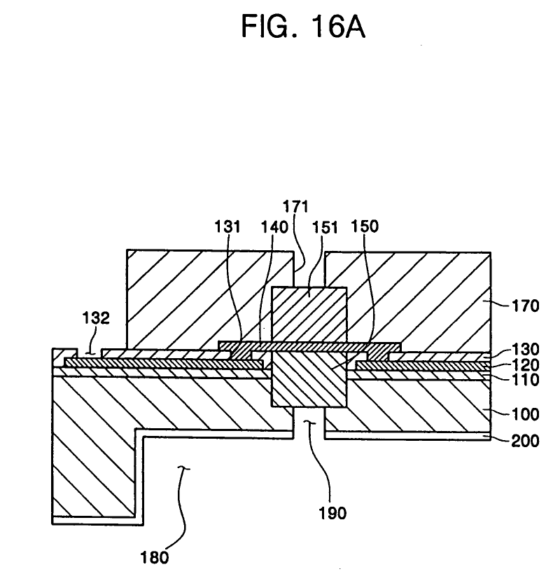

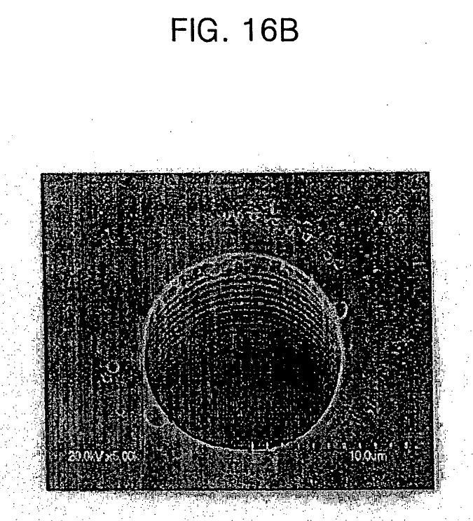

Once the ink channel pattern 201 is formed on the photomask 200, the substrate 100 may be dry etched to form the ink channel 190 by inductively coupled plasma etching, as illustrated in FIG. 16A. When the ink channel 190 is formed to have a circular shape, the ink channel 190 may have a width of about 10˜15 μm. A final state of the ink channel 190 is depicted in FIG. 16B. When the ink channel 190 is formed as described above, a diameter tolerance of the ink channel 190 may be controlled to be less than 1 μm.

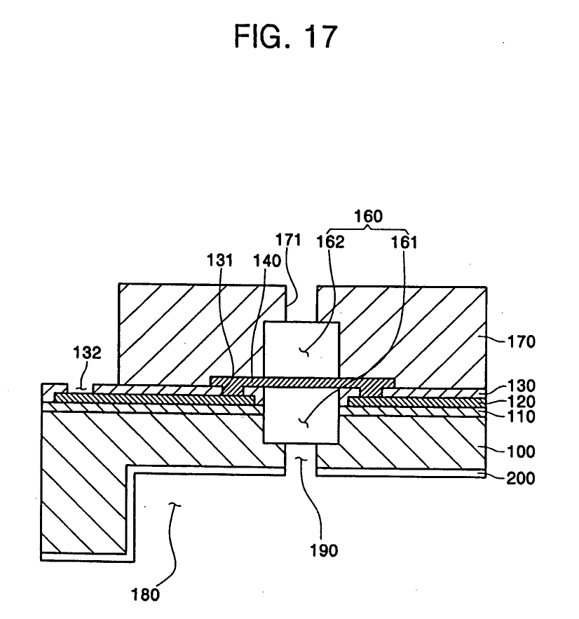

When the ink channel 190 is formed, the first and second sacrificial layers 150 and 151 are removed to create the first and second chambers 161 and 162, respectively, and to form a final passage through which the ink flows, as illustrated in FIG. 17.

The sacrificial layers 150 and 151 may be removed by an ashing process. The ashing process may use methyl, ethyl lactate, or glycol ether. When the sacrificial layers 150 and 151 are removed, the heater 140 that extends in parallel at an interface between the substrate 100 and the nozzle plate 170 is manufactured on the chamber 160.

As can be seen from the foregoing, the inkjet printer head in accordance with the present general inventive concept is capable of improving manufacturing process efficiency by omitting a process of separately forming a heater passivation layer. The present general inventive concept also allows the heater to be operated at low electric power by omitting the heater passivation layer, improving integrity of a nozzle by lowering a working voltage, and improving reliability in manufacturing processes by locating the suspended heater to be in parallel with the substrate and the electrode.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet printer head comprising:
a substrate having a manifold on a rear surface and an ink channel extending through the substrate to supply ink;
a nozzle plate formed on the substrate and having a nozzle;
a chamber formed between the substrate and the nozzle plate and extending toward the substrate and the nozzle plate to communicate with the ink channel, the manifold, and the nozzle;
an electrode formed at an interface between the substrate and the nozzle plate around the chamber; and
a heater having both ends extending in contact with the electrode to be suspended in the chamber in direct contact with the ink and to generate bubbles from both surfaces thereof.

2. The inkjet printer head according to claim 1, wherein the heater does not include a passivation layer formed on a surface thereof.

3. The inkjet printer head according to claim 1, wherein a photomask pattern to form the ink channel is formed on the rear surface of the substrate by a laser machining process.

4. The inkjet printer head according to claim 3, wherein the laser comprises a KrF excimer laser.

5. The inkjet printer head according to claim 1, wherein the ink channel is formed by inductively coupled plasma etching.

6. The inkjet printer head according to claim 1, wherein the chamber comprises a first chamber extending from the heater toward the substrate and a second chamber extending from the heater toward the nozzle plate.

7. The inkjet printer head according to claim 1, wherein both ends of the heater overlap with the electrode to be formed in parallel with the electrode and the substrate.

8. The inkjet printer head according to claim 7, wherein an insulating layer is formed between the heater and the electrode having a contact hole formed therein at which the heater overlaps with the electrode so that the heater is in contact with the electrode through the contact hole in the insulating layer.

9. The inkjet printer head according to claim 1, wherein the heater is formed to a thickness of about 1000˜3000 Å.

10. An inkjet printer head, comprising:
a substrate having an ink feed channel extending therethrough to supply ink from an ink container;
a nozzle layer disposed on the substrate and having at least one nozzle disposed above the ink feed channel;
an ink chamber disposed in the substrate and the nozzle layer between the nozzle and the ink feed channel; and
a heating part suspended in the ink chamber and disposed where the substrate meets the nozzle layer.

11. The inkjet printer head according to claim 10, wherein the ink chamber includes a first ink chamber disposed between the substrate and the heating part and a second ink chamber disposed between the nozzle and the heating part, and the heating part comprises an electrode formed at an interface between the substrate and the nozzle layer around the ink chamber and a heater disposed between the first and second ink chambers and having both ends extending in contact with the electrode to be suspended in the chamber in direct contact with the ink and to generate bubbles from both surfaces thereof.

12. The inkjet printer head according to claim 11, wherein the first ink chamber receives the ink from the ink feed channel and supplies ink to the second ink chamber.

13. The inkjet printer head according to claim 10, further comprising:
an electrode layer disposed between the substrate and the nozzle layer around the ink chamber and to contact the heating part.

14. The inkjet printer head according to claim 13, further comprising:
an insulating layer disposed between the electrode layer and the nozzle layer and having at least one contact hole therein to allow at least one end of the heating part to contact the electrode layer through the insulating layer.

15. The inkjet printer head according to claim 14, wherein both ends of the heating part contact the electrode layer through the at least one contact hole in the insulating layer so that the heating part is suspended in the ink chamber and is parallel to the substrate and the nozzle layer.

16. The inkjet printer head according to claim 10, wherein the heating part comprises a heat generating resistance that directly contacts the ink in the ink chamber without a passivation layer therebetween.

17. A method of manufacturing an inkjet head, the method comprising:
forming an electrode in which a chamber region is patterned on a substrate and forming an insulating layer on the electrode except for on the chamber region;
etching the chamber region into the substrate by a predetermined depth, filling the etched chamber region in the substrate with a first sacrificial layer, and planarizing the chamber region and the first sacrificial layer;
forming a heater on the first sacrificial layer to be in contact with the electrode on both ends thereof;
forming a second sacrificial layer on the heater and forming a nozzle plate having a nozzle on the second sacrificial layer;
forming a manifold in a rear surface of the substrate, forming an ink channel pattern to define an ink channel on a photomask formed on the manifold using a laser, and etching the ink channel; and
removing the first and second sacrificial layers to form a chamber that suspends the heater therein.

18. The method according to claim 17, wherein the heater comprises a surface on which a passivation layer is not formed so that the surface is directly exposed to the ink in the chamber.

19. The method according to claim 17, wherein the first and second sacrificial layers comprise organic compounds.

20. The method according to claim 17, wherein the first and second sacrificial layers are removed using one of methyl, ethyl lactate, and glycol ether.

21. The method according to claim 17, wherein the chamber comprises a first chamber formed by removing the first sacrificial layer and a second chamber formed by removing the second sacrificial layer, the first and second chambers being in fluid communication with each other.

22. The method according to claim 17, wherein the heater comprises both ends to overlap with the electrode.

23. The method according to claim 17, wherein the forming of the ink channel comprises:
coating a photoresist on the manifold to form a photomask;
irradiating the laser on the photomask to form the ink channel pattern; and
etching the ink channel pattern.

24. The method according to claim 23, wherein the ink channel is formed by inductively coupled plasma etching.

25. The method according to claim 17, wherein the laser comprises a KrF excimer laser.

26. The method according to claim 17, wherein the insulating layer at which both ends of the heater are located includes a contact hole formed so that the heater is in contact with the electrode through the insulating layer.

27. The method according to claim 17, wherein the heater is formed to a thickness of about 1000˜3000 Å.

28. The method according to claim 27, wherein the heater is formed of a material selected from a group including titanium nitride, tantalum, platinum, and tantalum nitride.

29. The method according to claim 17, wherein the chamber has a height not including a thickness of the heater of about 5˜15 μm.
